(19) United States
(12) Patent Application Publication
(10) Pub. No.: US 2005/0065251 A1
(43) Pub. Date: Mar. 24, 2005

(54) Composition containing an amino acid n-acylated ester and a polyamide-structured uv filter

(76) Inventors: Didier Candau, Bievres (FR); Christele Gombert, Lamorlaye (FR)

Correspondence Address: Finnegan Henderson Farabow;Garrett & Dunner, 1300 I Street NW, Washington, DC, 20005, US

(21) Appl. No.: 10/494,864

(22) PCT Filed: Nov. 8, 2002
(86) PCT No.: PCT/FR02/03839

(30) Foreign Application Priority Data
Nov. 9, 2001 (FR) 01/14530

(51) Int. Cl. C08L 1/00

(52) U.S. Cl. 524/238

(57) ABSTRACT

The invention concerns a cosmetic or dermatological composition structured by a polyamide, characterized in that it comprises at least an organic UV filter, and at least an amino acid N-acylated ester, its use in or for preparing compositions, in particular cosmetic and dermatological compositions for protecting the skin and/or the lips and/or skin appendages against ultraviolet radiation, in particular solar radiation. The invention also concerns a cosmetic treatment or protection method which consists in applying a cosmetic composition and, the use of at least an amino acid N-acylated ester in compositions structured by a polyamide containing an organic UV filter for enhancing solar protection factor of said composition.

The present invention relates to a composition structured with a polyamide, comprising at least one N-acylamino acid ester and an organic UV-screening agent, and also to its use for the manufacture of cosmetic or dermatological compositions for protecting the skin and/or the lips and/or the integuments against ultraviolet radiation, in particular sunlight.

It is known that light radiation with wavelengths of between 280 nm and 400 nm permits tanning of the human epidermis and that rays with wavelengths of between 280 and 320 nm, which are known as UV-B rays, cause skin burns and erythema that can disrupt the development of a natural tan; this UV-B radiation should thus be screened out.

It is also known that UV-A rays, with wavelengths of between 320 and 400 nm, which cause tanning of the skin, are liable to induce an impairment in the skin, especially in the case of sensitive skin or skin that is continually exposed to sunlight. UV-A rays in particular bring about a loss of elasticity of the skin and the appearance of wrinkles, leading to premature aging. They promote the triggering of the erythemal reaction or amplify this reaction in certain individuals and may even be the cause of phototoxic or photoallergic reactions. It is thus desirable also to screen out UV-A radiation.

Many cosmetic compositions for photoprotecting the skin (against UV-A and UV-B rays) have been proposed to date.

These antisun compositions are quite often in the form of an emulsion, of oil-in-water type (i.e. a cosmetically acceptable support consisting of an aqueous dispersing continuous phase and of a oily dispersed discontinuous phase), which contains, in various concentrations, one or more standard liposoluble organic screening agents and/or standard water-soluble organic screening agents capable of selectively absorbing the harmful UV radiation, these screening agents (and the amounts thereof) being selected as a function of the desired sun protection factor, the sun protection factor (SPF) being expressed mathematically as the ratio of the dose of UV radiation required to reach the erythema-forming threshold with the UV-screening agent to the dose of the UV radiation required to reach the erythema-forming threshold without the UV-screening agent.

The problem underlying the present patent application is that certain compositions, and especially compositions containing a liquid fatty phase, have a tendency to migrate in the wrinkles and fine lines of the skin. Now, such a migration, on mucous membranes or the eyes, of the composition and of the active principle it contains may cause irritation or at the very least inconvenience to the user.

In general, in cosmetic or dermatological products, it is common practice to find a structured, i.e. gelled and/or rigidified, liquid fatty phase, and this is especially the case in solid compositions, for instance deodorants, salves, lipsticks, concealer products and cast foundations. This structuring is generally obtained using waxes or fillers.

Advantageously and unexpectedly, the Applicant has found that the use of a particular polyamide makes it possible to limit or even prevent the migration of compositions containing this polyamide on the surface of the skin.

It has also been observed that the compositions according to the present invention, containing an N-acylamino acid ester and a particular polyamide, have the advantage of being able to dissolve a large number of active agents and especially UV-screening agents that are generally difficult to dissolve in cosmetic or dermatological compositions, especially in the compositions of the prior art.

The expression “composition structured with a polyamide” means a composition comprising a polyamide in an amount such that this composition is gelled and/or rigidified.

For the purposes of the present invention, the term “gelled composition” means a composition whose viscosity, measured under the following conditions: Rheomat 180 viscometer sold by the company Mettler Toledo equipped with Contraves TV equipment with an adapter for an MSR 1 to 5 standardized system, measured in a bath thermostatically maintained at 25° C., at a spindle rotation speed set at 200 rpm, is between 0.01 and 60 poises, after a shear of 30 seconds at 200 rpm.

For the purposes of the present invention, the term “rigidified composition” means a composition with a hardness ranging from 20 to 2000 g, preferably from 20 to 1500 g and even more preferably from 20 to 900 g, for example from 150 to 600 g.

This hardness may be measured according to a method of penetrating a probe into said composition and in particular using a texture analyzer (for example TA-XT2i from Rheo) equipped with an ebonite cylinder 25 mm tall and 8 mm in diameter. The hardness measurement is performed at 20° C. at the center of 5 samples of said composition. The cylinder is introduced into each sample of composition at a prespeed of 2 mm/s and then at a speed of 0.5 mm/s, and finally at a postspeed of 2 mm/s, the total displacement being 1 mm. The hardness value recorded is that of the maximum peak. The measuring error is ±50 g.

The compositions according to the present invention also have the advantage of having improved photoprotective and cosmetic properties. These compositions give the skin a sensation of softness and freshness, prevent the skin from drying out and from feeling too greasy, and make it possible to limit the migration of the composition in the area of the eyes and the mucous membranes. The application is also more uniform and of improved efficacy.

The cosmetic or dermatological composition according to the present invention comprises a liquid fatty phase, especially containing the N-acylamino acid ester, UV-screening agents and the polyamide.

For the purposes of the present patent application, the term “liquid fatty phase” means a fatty phase that is liquid at room temperature (25° C.) and atmospheric pressure (760 mmHg), composed of one or more mutually compatible fatty substances that are liquid at room temperature, also known as oils.

The particular polyamides used in the composition according to the present invention are those described in document U.S. Pat. No. 5,783,657 from the company Union Camp. The portion of U.S. Pat. No. 5,783,657 devoted to these polymers is incorporated by reference.

Each of these polymers especially satisfies the following formula: 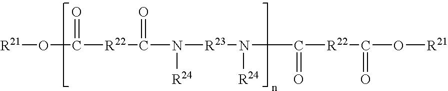
in which n denotes a whole number of amide units such that the number of ester groups represents from 10% to 50% of the total number of ester and amide groups; R²¹ is, independently in each case, an alkyl or alkenyl group containing at least 4 carbon atoms and in particular from 4 to 24 carbon atoms; R²² represents, independently in each case, a C₄ to C₅₅ hydrocarbon-based group, on condition that 50% of the groups R²² represent a C₃₀ to C₅₅ hydrocarbon-based group; R²³ represents, independently in each case, an organic group containing at least 2 carbon atoms, hydrogen atoms and optionally one or more oxygen or nitrogen atoms; and R²⁴ represents, independently in each case, a hydrogen atom, a C₁ to C₁₀ alkyl group or a direct bond to R²³ or to another R²⁴, such that the nitrogen atom to which R²³ and R²⁴ are both attached forms part of a heterocyclic structure defined by R²⁴—N—R²³, with at least 50% of the groups R²⁴ representing a hydrogen atom.

In particular, the ester groups of this polyamide represent from 15% to 40% of the total number of ester and amide groups and better still from 20% to 35%. Furthermore, n advantageously represents an integer ranging from 1 to 5, limits inclusive.

Preferably, R²¹ is a C₁₂ to C₂₂ and preferably C₁₆ to C₂₂ alkyl group. Advantageously, R²² can be a C₁₀ to C₄₂ hydrocarbon-based (alkylene) group. Preferably, at least 50% and better still at least 75% of the groups R²² are groups containing from 30 to 42 carbon atoms. The other groups R²² are C₄ to C₁₉ and preferably C₄ to C₁₂ hydrogen-containing groups. Preferably, R²³ represents a C₂ to C₃₆ hydrocarbon-based group or a polyoxyalkylene group and R²⁴ represents a hydrogen atom. Preferably, R²³ represents a C₂ to C₁₂ hydrocarbon-based group.

The hydrocarbon-based groups may be linear, cyclic or branched, and saturated or unsaturated groups. Moreover, the alkyl and alkylene groups may be linear or branched and saturated or unsaturated groups.

According to the invention, the structuring of the liquid fatty phase is obtained with the aid of one or more polyamides defined above. In general, these polyamides are in the form of mixtures, these mixtures also possibly containing a synthetic product corresponding to a polyamide as defined obove in which n is 0, i.e. a diester.

As structuring polyamide that may be used in the invention, mention may also be made of polyamide resins resulting from the condensation of an aliphatic dicarboxylic acid and a diamine (including compounds containing more than 2 carbonyl groups and 2 amine groups), the carbonyl and amine groups of adjacent individual units being condensed in the form of an amide bond. These polyamide resins are, in particular, those sold under the brand name Versamid® by the companies General Mills, Inc. and Henkel Corp., under the brand name Onamid®, in particular Onamid S or C. These resins have a weight-average molecular mass ranging from 6000 to 9000. For further information regarding these polyamides, reference may be made to documents U.S. Pat. No. 3,645,705 and U.S. Pat. No. 3,148,125. More especially, Versamid® 930 or 744 is used.

The polyamides sold or manufactured by the company Arizona under the references Uni-Rez (2658, 2931, 2970, 2621, 2613, 2624, 2665, 1554, 2623 and 2662) and the product sold under the reference Macromelt 6212 by the company Henkel may also be used. For further information regarding these polyamides, reference may be made to document U.S. Pat. No. 5,500,209.

As examples of structuring polyamides that may be used in the composition according to the invention, mention may also be made of the commercial products sold or manufactured by the company Arizona Chemical under the names Uniclear 80 and Uniclear 100. They are sold, respectively, in the form of an 80% (in terms of active material) gel and a 100% (in terms of active material) gel in a mineral oil. They have a softening point of from 88 to 94° C. These commercial products are a mixture of copolymers of a C₃₆ diacid coupled with ethylenediamine, having a weight-average molecular mass of about 6000. The terminal ester groups result from the esterification of the remaining acid endings with cetyl alcohol, stearyl alcohol or mixtures thereof (also known as cetylstearyl alcohol).

The structuring polyamides in the composition of the invention advantageously have a softening point of greater than 60° C., which may be up to 190° C. They preferably have a softening point of less than 150° C., ranging from 70 to 130° C. and better still from 80 to 105° C. This softening point is lower than that of known structuring polymers, thus facilitating the use of the polymers that are the subject of the invention and limiting the degradation of the liquid fatty phase. The polyamides used in the present patent application have, on account of their fatty chain, good solubility in oils (i.e. water-immiscible liquid compounds) and thus produce macroscopically homogeneous compositions, even with a high polymer content (at least 25%), in contrast to the fatty-chain-free polymers of the prior art.

Advantageously, the polyamide is combined with a linear or branched fatty alcohol such as oleyl alcohol, isocetyl alcohol or octyldodecanol. In practice, the amount of polyamide (as active material) represents from 0.5% to 80% and better still from 5% to 40% of the total weight of the composition.

The N-acylamino acid ester is an ester of formula:
R′¹(CO)N(R′₂)CH(R′₃)(CH₂)ₙ(CO)OR′₄
in which:
n is an integer equal to 0, 1 or 2,
R′₁ represents a linear or branched C₅ to C₂₁ alkyl or alkenyl radical,
R′₂ represents a hydrogen atom or a C₁ to C₃ alkyl group,
R′₃ represents a radical chosen from the group formed by a hydrogen atom, a methyl group, an ethyl group and a linear or branched C₃ or C₄ alkyl radical,
R′₄ represents a linear or branched C₁ to C₁₀ alkyl radical or a linear or branched C₂ to C₁₀ alkenyl radical or a sterol residue.

In the above formula, the group R′₁(CO)— is an acyl group of an acid preferably chosen from the group formed by capric acid, lauric acid, myristic acid, palmitic acid, stearic acid, behenic acid, linoleic acid, linolenic acid, oleic acid, isostearic acid, 2-ethylhexanoic acid, coconut oil fatty acids, palm kernel oil fatty acids and hydrogenated palm kernel oil fatty acids. These fatty acids may also contain a hydroxyl group. Even more preferably, the fatty acid will be lauric acid.

The portion —N(R′₂)CH(R′₃)(CH₂)ₙ(CO)— of the N-acylamino acid ester is preferably chosen from the following amino acids: glycine, alanine, valine, leucine, isoleucine, serine, threonine, proline, hydroxyproline, β-alanine, aminobutyric acid, aminocaproic acid, sarcosine or N-methyl-β-alanine.

Even more preferably, the amino acid will be sarcosine.

The portion of the N-acylamino acid esters corresponding to the group OR′₄ may be obtained from alcohols chosen from the group formed by methanol, ethanol, propanol, isopropanol, butanol, tert-butanol, isobutanol, 3-methyl-1-butanol, 2-methyl-1-butanol, fusel oil, pentanol, hexanol, cyclohexanol, octanol, 2-ethylhexanol, decanol, lauryl alcohol, myristyl alcohol, cetyl alcohol, cetostearyl alcohol, stearyl alcohol, oleyl alcohol, behenyl alcohol, jojoba alcohol, 2-hexadecyl alcohol, 2-octyldodecyl alcohol and isostearyl alcohol.

These N-acylamino acid esters may be obtained in particular from natural sources of amino acids. In this case, the amino acids are obtained from the hydrolysis of natural proteins of plants (oat, wheat, soybean, palm or coconut) and then necessarily lead to mixtures of amino acids that will subsequently have to be esterified and then N-acylated. The preparation of such amino acids is more particularly described in patent application FR 2 796 550, which is incorporated herein by reference.

The amino acid ester that is more particularly preferred for its use in the present invention is isopropyl N-lauroylsarcosinate of formula:
CH₃—(CH₂)₁₀CO—N(CH₃)—CH₂—COO—CH₂—(CH₃)₂.

These N-acylamino acid esters and the process for synthesizing them are described in patent applications EP 1 044 676 and EP 0 928 608 belonging to the company Ajinomoto Co.

The organic photoprotective agents are especially chosen from anthranilates; cinnamic derivatives; dibenzoylmethane derivatives; salicylic derivatives; camphor derivatives; triazine derivatives, preferably 1,3,5-triazine derivatives such as those described in patent applications U.S. Pat. No. 4,367,390, U.S. Pat. No. 4,724,137, EP 863 145, EP 517 104, EP 570 838, EP 796 851, EP 775 698, EP 878 469, EP 933 376, EP 506 691, EP 507 692, EP 790 243 and EP 944 624; benzophenone derivatives; β,β′-diphenylacrylate derivatives; benzotriazole derivatives; benzalmalonate derivatives; benzimidazole derivatives; imidazolines; bis-benzazolyl derivatives as described in patents EP 669 323 and U.S. Pat. No. 2,463,264; p-aminobenzoic acid (PABA) derivatives; methylenebis(hydroxyphenyl)benzotriazole derivatives as described in patent applications U.S. Pat. No. 5,237,071, U.S. Pat. No. 5,166,355, GB 2 303 546, DE 197 26 184 and EP 893 119; screening polymers and screening silicones such as those described especially in patent application WO 93/04665; dimers derived from α-alkylstyrene such as those described in patent application DE 198 55 649; 4,4-diarylbutadienes such as those described in patent applications EP 0 967 200 and DE 197 55 649, and mixtures thereof.

As examples of UV-A-active and/or UV-B-active organic photoprotective agents, mention may be made of the following, denoted hereinbelow under their INCI name:

para-Aminobenzoic acid derivatives:
PABA,
Ethyl PABA,
Ethyl dihydroxypropyl PABA (Amerscreen P sold by Amerchol),
Ethylhexyl dimethyl PABA sold in particular under the name “Escalol 507” by ISP,
Glyceryl PABA,
PEG-25 PABA sold under the name “Uvinul P25” by BASF.

Salicylic derivatives:
Homosalate sold under the name “Eusolex HMS” by Rona/EM Industries,
Ethylhexyl salicylate sold under the name “Neo Heliopan OS” by Haarmann and Reimer,
Dipropylene glycol salicylate sold under the name “Dipsal” by Scher,
TEA salicylate sold under the name “Neo Heliopan TS” by Haarmann and Reimer.

Dibenzoylmethane derivatives:
Butyl methoxydibenzoylmethane sold in particular under the trade name “Parsol 1789” by Hoffmann LaRoche,
Isopropyldibenzoylmethane.

Cinnamic derivatives:
Ethylhexyl methoxycinnamate sold in particular under the trade name “Parsol MCX” by Hoffmann LaRoche,
Isopropyl methoxycinnamate,
Isoamyl methoxycinnamate sold under the trade name “Neo Heliopan E 1000” by Haarmann and Reimer,
Cinoxate,
DEA methoxycinnamate,
Glyceryl ethylhexanoate dimethoxycinnamate.

β,β′-Diphenyl acrylate derivatives:
Octocrylene sold in particular under the trade name “Uvinul N539” by BASF,
Etocrylene sold in particular under the trade name “Uvinal N35” by BASF.

Benzophenone derivatives:
Benzophenone-1 sold under the trade name “Uvinul 400” by BASF,
Benzophenone-2 sold under the trade name “Uvinul D50” by BASF,
Benzophenone-3 or Oxybenzone sold under the trade name “Uvinul M40” by BASF,
Benzophenone-4 sold under the trade name “Uvinul MS40” by BASF,
Benzophenone-5,
Benzophenone-6 sold under the trade name “Helisorb 11” by Norquay,
Benzophenone-8 sold under the trade name “Spectra-Sorb UV-24” by American Cyanamid,
Benzophenone-9 sold under the trade name “Uvinul DS-49” by BASF,
Benzophenone-12.

Benzylidenecamphor derivatives:
3-Benzylidenecamphor manufactured under the name “Mexoryl SD” by Chimex,
4-Methylbenzylidenecamphor sold under the name “Eusolex 6300” by Merck,
Benzylidenecamphorsulfonic acid manufactured under the name “Mexoryl SO” by Chimex,
Camphor benzalkonium methosulfate manufactured under the name “Mexoryl SO” by Chimex,
Terephthalylidenedicamphorsulfonic acid manufactured under the name “Mexoryl SX” by Chimex,
Polyacrylamidomethylbenzylidenecamphor manufactured under the name “Mexoryl SW” by Chimex.

Benzimidazole derivatives:
Phenylbenzimidazolesulfonic acid sold in particular under the trade name “Eusolex 232” by Merck,
Disodium phenyldibenzimidazoletetrasulfonate sold under the trade name “Neo Heliopan AP” by Haarmann and Reimer.

Triazine derivatives:
Anisotriazine sold under the trade name “Tinosorb S” by Ciba Specialty Chemicals,
Ethylhexyltriazone sold in particular under the trade name “Uvinul T150” by BASF,
Diethylhexylbutamidotriazone sold under the trade name “Uvasorb HEB” by Sigma 3V,
2,4,6-Tris(diisobutyl 4′-aminobenzalmalonate) s-triazine.

Benzotriazole derivatives:
Drometrizole trisiloxane sold under the name “Silatrizole” by Rhodia Chimie,
Methylenebis(benzotriazolyl)tetramethylbutylphenol sold in solid form under the trade name “MIXXIM BB/100” by Fairmount Chemical, or in micronized form as an aqueous dispersion under the trade name “Tinosorb M” by Ciba Specialty Chemicals.

Anthranilic derivatives:
Menthyl anthranilate sold under the trade name “Neo Heliopan MA” by Haarmann and Reimer.

Imidazoline derivatives:
Ethylhexyldimethoxybenzylidenedioxoimidazoline propionate.

Benzalmalonate derivatives:
Polyorganosiloxane, containing benzalmalonate functions, sold under the trade name “Parsol SLX” by Hoffmann LaRoche,
   and mixtures thereof.

The organic photoprotective agents that are more particularly preferred are chosen from the following compounds:
Ethylhexyl salicylate,
Butyl methoxydibenzoylmethane,
Ethylhexyl methoxycinnamate,
Octocrylene,
Phenylbenzimidazolesulfonic acid,
Terephthalylidenedicamphorsulfonic acid,
Benzophenone-3,
Benzophenone-4,
Benzophenone-5,
4-Methylbenzylidenecamphor,
Disodium Phenyl Dibenzimidazole Tetra-Sulfonate
Anisotriazine,
Ethylhexyltriazone,
Diethylhexylbutamidotriazone,
Methylenebis(benzotriazolyl)tetramethylbutylphenol,
Drometrizole trisiloxane,
2-[(p-(tert-butylamido)anilino]-4,6-bis[(p-(2′-ethylhexyl-1′-oxycarbonyl)anilino]-1,3,5-triazine,
2,4,6-tris[p′-(2′-ethylhexyl-1′-oxycarbonyl)-anilino]-1,3,5-triazine,
2,4-bis{[4-(2-ethylhexyloxy)-2-hydroxy]phenyl}-6-(4-methoxyphenyl)-1,3,5-triazine,
2,4,6-tris(diisobutyl 4′-aminobenzalmalonate)-s-triazine,
   and mixtures thereof.

The composition according to the present invention preferably comprises, in a physiologically acceptable medium, from 0.5% to 80% and preferably from 5% to 40% of polyamides by weight, relative to the total weight of the composition.

The compositions according to the present invention preferably comprise, in a physiologically acceptable medium, from 0.05% to 30% and preferably from 0.1% to 25% of at least one UV-screening agent by weight, relative to the total weight of said composition.

The compositions according to the present invention preferably comprise, in a physiologically acceptable medium, from 0.1% to 60%. and preferably from 1% to 30% of N-acylamino acid esters by weight, relative to the total weight of the composition.

Said composition may also comprise nacres, pigments or nanopigments (mean size of the primary particles: generally between 5 nm and 100 nm and preferably between 10 nm and 50 nm) of coated or uncoated metal oxides such as, for example, nanopigments of titanium oxide (amorphous or crystallized in rutile and/or anatase form), of iron oxide, of zinc oxide, of zirconium oxide and of cerium oxide, and mixtures thereof, all these being UV photoprotective agents that are well known per se. Standard coating agents are, moreover, alumina and/or aluminum stearate. Such coated or uncoated metal oxide nanopigments are described in particular in patent applications EP-A-0 518 772 and EP-A-0 518 773.

The compositions according to the invention may also contain agents for artificially tanning and/or browning the skin (self-tanning agents), for instance dihydroxyacetone (DHA).

The dermatological compositions according to the present invention may also comprise at least one active agent chosen from antioxidants, free-radical scavengers, α-hydroxy acids, vitamins, insect repellents, anti-inflammatory agents and substance P antagonists.

The compositions of the invention may also comprise conventional cosmetic adjuvants chosen especially from fatty substances, organic solvents other than those specifically used in the context of
the present invention, emulsifiers, ionic or nonionic thickeners, softeners, opacifiers, stabilizers, emollients, silicones, antifoams, moisturizers, vitamins, fragrances, preserving agents, surfactants, fillers, polymers, propellants, acidifying or basifying agents, colorants or any other ingredient usually used in cosmetics, in particular for manufacturing antisun compositions in the form of emulsions.

The fatty substances may consist of an oil or a wax or mixtures thereof, and they also comprise fatty acids, fatty alcohols and fatty acid esters. The oils may be chosen from animal, plant, mineral and synthetic oils and especially from liquid petroleum jelly, liquid paraffin, silicone oils, which may be volatile or nonvolatile, isoparaffins, polyolef ins, fluoro oils and perfluoro oils. Similarly, the waxes may be chosen from animal, fossil, plant, mineral and synthetic waxes that are known per se.

Among the polar oils that may be mentioned are Finsolv TN, tridecyl trimellitate, isononyl isononanoate, isopropyl myristate, dicaprylyl carbonate, Guerbet alcohol benzoates and hydroxybenzoates, for instance Hallbrite BHB from CP Hall Company.

Among the organic solvents that may be mentioned are lower alcohols and polyols.

Needless to say, a person skilled in the art will take care to select this or these optional additional compound(s) and/or the amounts thereof such that the advantageous properties are not, or are not substantially, adversely affected by the envisaged addition(s).

The compositions of the invention may be prepared according to techniques that are well known to those skilled in the art, in particular those intended for preparing emulsions of oil-in-water (O/W) or water-in-oil (W/O) type.

These compositions may be in particular in the form of a simple or complex emulsion (O/W, W/O, O/W/O) or triple emulsion (W/O/W, O/W/O) such as a cream, a milk, a gel or a cream-gel, a powder or a solid stick, and may optionally be packaged as an aerosol and be in the form of a mousse or a spray.

When it is an emulsion, the aqueous phase of this emulsion may comprise a nonionic vesicular dispersion prepared according to known processes (Bangham, Standish and Watkins, J. Mol. Biol. 13, 238 (1965), FR 2 315 991 and FR 2 416 008).

The cosmetic composition of the invention may be used as a composition for protecting the human epidermis or the hair against ultraviolet rays, as an antisun composition or as a makeup product.

When the cosmetic composition according to the invention is used for protecting the human epidermis against UV rays, or as an antisun composition, it may be in the form of a suspension or a dispersion in solvents or fatty substances, in the form of a nonionic vesicular dispersion or in the form of an emulsion, preferably of oil-in-water type, such as a cream or a milk, or in the form of an ointment, a gel, a cream-gel, a solid stick, a powder, a wand, an aerosol mousse or a spray.

When the cosmetic composition according to the invention is used for protecting the hair against UV rays, it may be in the form of a shampoo, a lotion, a gel, an emulsion or a nonionic vesicular dispersion and may constitute, for example, a rinse-out composition, to be applied before or after shampooing, before or after dyeing or bleaching, before, during or after permanent-waving or straightening the hair, a styling or treating lotion or gel, a blow-drying or hairsetting lotion or gel, or a composition for permanent-waving, straightening, dyeing or bleaching the hair.

When the composition is used as a makeup product for the nails, the eyelashes, the eyebrows or the skin, such as an epidermal treatment cream, a foundation, a tube of lipstick, an eyeshadow, a face powder, a mascara or an eyeliner, it may be in solid or pasty, anhydrous or aqueous form, for instance oil-in-water or water-in-oil emulsions, nonionic vesicular dispersions or suspensions.

As a guide, for the antisun formulations in accordance with the invention, which contain a support of oil-in-water emulsion type, the aqueous phase (containing, in particular, hydrophilic screening agents) generally represents from 50% to 95% by weight and preferably from 70% to 90% by weight, relative to the total formulation, the oily phase (containing, in particular, lipophilic screening agents) generally represents from 5% to 50% by weight and preferably from 10% to 30% by weight, relative to the total formulation, and the (co)emulsifier(s) generally represent(s) from 0.5% to 20% by weight and preferably from 2% to 10% by weight, relative to the total formulation.

In particular, the compositions according to the present invention may be obtained in the form of an anhydrous composition that has quite noteworthy. transparency and translucency properties.

The term “anhydrous composition” generally means a composition that is essentially free of water, i.e. containing less than 5% and preferably less than 1% by weight of water relative to the total composition. Said anhydrous composition according to the present invention comprises between 0.05% and 15% by weight of 1,3,5-triazine derivative, from 0.1% to 60% of N-acylamino acid ester and from 0.5% to 35% of polyamide. These compositions also optionally contain a liposoluble dye.

A subject of the present patent application is also the composition containing at least one N-acylamino acid ester and an organic UV-screening agent, structured with a particular polyamide, as a cosmetic or dermatological composition, and also a cosmetic process for treating or protecting the skin and/or the lips and/or the integuments against UV radiation, in particular sunlight, characterized by the application of said cosmetic composition to the skin, the integuments (eyelashes, nails or hair) or the lips.

A subject of the present patent application is also the use of a composition according to the present invention for the manufacture of an antisun product, an antisun makeup product for the skin, the lips and/or the integuments, or a dermatological composition for caring for and/or treating the skin.

Another subject of the present patent application consists of the use of at least one N-acylamino acid ester of formula
R′¹(CO)N(R′₂)CH(R′₃)(CH₂)ₙ(CO)OR′₄
in which:
n is an integer equal to 0, 1 or 2,
R′₁ represents a linear or branched C₅ to C₂₁ alkyl or alkenyl radical,
R′₂ represents a hydrogen atom or a C₁ to C₃ alkyl group,
R′₃ represents a radical chosen from the group formed by a hydrogen atom, a methyl group, an ethyl group and a linear or branched C₃ or C₄ alkyl radical,
R′₄ represents a linear or branched C₁ to C₁₀ alkyl radical or a linear or branched C₂ to C₁₀ alkenyl radical or a sterol residue,
   in compositions structured with a polyamide, containing a UV-screening agent, in order to improve the sun protection factor of this composition.

The composition according to the invention may be in the form of a dermatological tinted composition or a care composition for keratin materials such as the skin, the lips and/or the integuments, in the form of an antisun or body hygiene composition especially in the form of a deodorant product or makeup-removing product in stick form. It may be used especially as a care base for the skin, the integuments or the lips (lip salves, for protecting the lips against cold and/or sunlight and/or wind, or a care cream for the skin, the nails or the hair).

The composition of the invention may also be in the form of a colored antisun skin makeup product, in particular a foundation, optionally having care or treatment properties, a blusher, a makeup rouge, an eyeshadow, a concealer product, an eyeliner or a body makeup product; a lip makeup product, for instance a lipstick, optionally having care or treatment properties; a makeup product for the integuments, for instance the nails and the eyelashes, in particular in the form of a cake mascara, or for the eyebrows or the hair, especially in the form of a pencil. In particular, the composition of the invention may be a cosmetic or dermatological product containing cosmetic and/or dermatological active agents.

Needless to say, the composition of the invention should be cosmetically or dermatologically acceptable, i.e. it should contain a nontoxic physiologically acceptable medium that may be applied to human skin, integuments or lips. For the purposes of the invention, the term “cosmetically acceptable” means a composition of pleasant appearance, odor and feel.

According to the invention, the composition contains a dyestuff that may be chosen from the lipophilic dyes, hydrophilic dyes, pigments and nacres usually used in cosmetic or dermatological compositions, and mixtures thereof. This dyestuff is generally present in a proportion of from 0.01% to 40%, preferably from 1% to 35% and better still from 5% to 25% relative to the total weight of the composition.

Preferably, the liposoluble dye contains essentially pigments and/or nacres in order to obtain a covering makeup, i.e. a makeup that does not leave the skin, the lips or the integuments showing through, The pigments also make it possible to reduce the tacky feel of the compositions, in contrast to soluble dyes.

The liposoluble dyes are, for example, Sudan red, DC Red 17, DC Green 6, β-carotene, soybean oil, Sudan brown, DC Yellow 11, DC Violet 2, DC Orange 5, quinoline yellow or annatto. They may represent from 0 to 20% of the weight of the composition and better still from 0.1% to 6% (if present).

The pigments may be white or colored, mineral and/or organic, and coated or uncoated. Among mineral pigments, mention may be made of titanium dioxide or zinc dioxide, which is optionally surface-treated, zirconium oxide or cerium oxide, and also iron oxide, chromium oxide, manganese violet, ultramarine blue, chromium hydrate and ferric blue. Among organic pigments, mention may be made of carbon black, pigments of D & C type, and lacquers based on cochineal carmine or on barium, strontium, calcium or aluminum. The pigments may represent from 0 to 40%, preferably from 1% to 35% and better still from 2% to 25% of the total weight of the composition.

The nacreous pigments (or nacres) may be chosen from white nacreous pigments, such as mica coated with titanium or with bismuth oxychloride, colored nacreous pigments such as titanium mica with iron oxides, titanium mica with, in particular, ferric blue or chromium oxide, titanium mica with an organic pigment of the abovementioned type, and also nacreous pigments based on bismuth oxychloride. They can represent from 0 to 20% of the total weight of the composition, and better still from 0.1% to 15% (if present).

The composition according to the invention may be manufactured by the known processes generally used in cosmetics or dermatology. It may be manufactured by the process that consists in heating the polymer at least to its softening point, adding thereto the amphiphilic compound(s), the dyestuffs and the additives and then mixing everything together until a clear transparent solution is obtained. The homogeneous mixture obtained may then be cast in a suitable mold, for instance a lipstick mold, or cast directly into packaging articles (especially a case or dish).

The examples that follow illustrate the invention without limiting its scope.

### EXAMPLES

Compositions of examples 1 to 5 in accordance with the invention are obtained by mixing together the following compounds:

| COMPOSITION Example 1 | weight % |
|---|---|
| Octyl triazone (Uvinul T150 - BASF) | 5 |
| Butylmethoxydibenzoylmethane | 2 |
| (Parsol 1789 - Hoffmann LaRoche) | |
| Drometrizole trisiloxane | 5 |
| (Silatrizole - Rhodia Chimie) | |
| Polycondensate of a C36 dimeric acid and of | 1.8 |
| ethylenediamine esterified with a C16/C18 | |
| alcohol (Uniclear 100V) | |
| 2-Octyldodecanol (Eutanol G - Cognis) | 42.2 |
| Isopropyl lauroyl sarcosinate | 43.9991 |
| (Eldew SL-205 - Ajinomoto) | |
| Sudan Red R | 0.0006 |
| (Ecarlate au gras W 3200 - Wackherr) | |
| Alizurol Purple SS | 0.00015 |
| (Alizarin violet 3B/Base - ACNA) | |
| Quinoline Yellow SS | 0.00015 |
| (DC Yellow 011-90096 - Anstead) | |

| COMPOSITION Example 2 | weight % |
|---|---|
| Butylmethoxydibenzoylmethane | 2 |
| (Parsol 1789 - Hoffmann LaRoche) | |
| Drometrizole trisiloxane | 5 |
| (Silatrizole - Rhodia Chimie) | |
| Polycondensate of a C36 dimeric acid and of | 26.4 |
| ethylenediamine esterified with a C16/C18 | |
| alcohol (Uniclear 100V) | |
| 2-Octyldodecanol (Eutanol G - Cognis) | 8.8 |
| Isopropyl lauroyl sarcosinate | 57.7991 |
| (Eldew SL-205 - Ajinomoto) | |
| Sudan Red R | 0.0006 |
| (Ecarlate au gras W 3200 - Wackherr) | |
| Alizurol Purple SS | 0.00015 |
| (Alizarin violet 3B/Base - ACNA) | |
| Quinoline Yellow SS | 0.00015 |
| (DC Yellow 011-90096 - Anstead) | |

| COMPOSITION Example 3 | weight % |
|---|---|
| Octyl triazone (Uvinul T150 - BASF) | 5 |
| Butylmethoxydibenzoylmethane | 2 |
| (Parsol 1789 - Hoffmann LaRoche) | |
| Drometrizole trisiloxane | 5 |
| (Silatrizole - Rhodia Chimie) | |
| Polycondensate of a C36 dimeric acid and of | 6 |
| ethylenediamine esterified with a C16/C18 | |
| alcohol (Uniclear 100V) | |
| 2-Octyldodecanol (Eutanol G - Cognis) | 2 |
| Isopropyl lauroyl sarcosinate | 11 |
| (Eldew SL-205 - Ajinomoto) | |
| Glyceryl mono/distearate/Polyethylene glycol | 2 |
| stearate (100 EO) mixture | |
| (Arlacel 165 FL - Uniqema) | |
| Glyceryl mono/distearate | 2 |
| (50/50 Glyceryl stearate - Stéarinerie Dubois) | |
| Methyl, butyl, ethyl, propyl and isobutyl | 0.25 |
| p-hydroxybenzoate mixture | |
| (Nipastat - NIPA) | |
| Ethylenediaminetetra (methylenephosphonic acid), | 0.3 |
| pentasodium salt, as an aqueous solution | |
| (Dequest 2046 - Solutia) | |
| Polyacrylic acid (Synthalen K - 3V SA) | 0.2 |
| Triethanolamine | 0.2 |
| (Triethanolamine 99% minimum - BASF) | |
| Microbiologically clean deionized water | qs 100 |

| COMPOSITION Example 4 | weight % |
|---|---|
| Oxyethylenated and oxypropylenated (35/3) (18 | 2 |
| EO/18 PO) polymethyllauryl/methylsiloxane | |
| (Dow Corning 5200 Formulation Aid - Dow | |
| Corning) | |
| Polyethylene glycol dipolyhydroxystearate (30 | 2 |
| EO) (Arlacel P135 - Uniqema (ICI)) | |
| Isopropyl lauroyl sarcosinate | 11 |
| (Eldew SL-205 - Ajinomoto) | |
| Isohexadecane (Permethyl 101A - Bayer - General | 11 |
| Bayer Silicones) | |
| 2-Ethylhexyl glyceryl ether | 0.75 |
| (Sensiva SC 50 - Schulke & Mayr) | |
| Octyl triazone (Uvinul T150 - BASF) | 5 |
| Butylmethoxydibenzoylmethane | 2.5 |
| (Parsol 1789 - Hoffmann LaRoche) | |
| Drometrizole trisiloxane | 0.5 |
| (Silatrizole - Rhodia Chimie) | |
| Polycondensate of a C36 dimeric acid and of | 1 |
| ethylenediamine esterified with a C16/C18 | |
| alcohol (Uniclear 100V) | |
| Octyltrimethoxysilane-treated titanium oxide | 5 |
| (25 to 40 nm) (Uvinul T102 - BASF) | |
| Sodium chloride | 1 |
| Glycerol (Atochem) | 4 |
| Propylene glycol | 4 |
| Ethylenediaminetetra (methylenephosphonic acid), | 0.3 |
| pentasodium salt, as an aqueous solution | |
| (Dequest 2046 - Solutia) | |
| [1,4-Divinylbenzene]-B,B′-camphorsulfonic acid | 0.9 |
| as an aqueous solution (Mexoryl SX - Chimex) | |
| Triethanolamine | 0.16 |
| (Triethanolamine 99% minimum - BASF) | |
| Microbiologically clean deionized water | qs 100 |

| COMPOSITION Example 5 | weight % |
|---|---|
| Oxyethylenated and oxypropylenated (35/3) (18 | 2 |
| EO/18 PO) polymethyllauryl/methylsiloxane | |
| (Dow Corning 5200 Formulation Aid - Dow | |
| Corning) | |
| Polyethylene glycol dipolyhydroxystearate (30 | 2 |
| EO) (Arlacel P135 - Uniqema (ICI)) | |
| Isopropyl lauroyl sarcosinate | 11 |
| (Eldew SL-205 - Ajinomoto) | |
| Isohexadecane (Permethyl 101A - Bayer - General | 11 |
| Bayer Silicones) | |
| 2-Ethylhexyl glyceryl ether | 0.75 |
| (Sensiva SC 50 - Schulke & Mayr) | |
| Butylmethoxydibenzoylmethane | 2.5 |
| (Parsol 1789 - Hoffmann LaRoche) | |
| Drometrizole Trisiloxane | 0.5 |
| (Silatrizole - Rhodia Chimie) | |
| Polycondensate of a C36 dimeric acid and of | 1 |
| ethylenediamine esterified with a C16/C18 | |
| alcohol (Uniclear 100V) | |
| Octyltrimethoxysilane-treated titanium oxide | 5 |
| (25 to 40 nm) (Uvinul T102 - BASF) | |
| Sodium chloride | 1 |
| Glycerol (Atochem) | 4 |
| Propylene glycol | 4 |
| Ethylenediaminetetra (methylenephosphonic acid), | 0.3 |
| pentasodium salt, as an aqueous solution | |
| (Dequest 2046 - Solutia) | |
| [1,4-Divinylbenzene]-β,β′-camphorsulfonic acid | 0.9 |
| as an aqueous solution (Mexoryl SX - Chimex) | |
| Triethanolamine | 0.16 |
| (Triethanolamine 99% minimum - BASF) | |
| Microbiologically clean deionized water | qs 100 |

1. Cosmetic or dermatological composition structured with a polyamide, characterized in that it comprises:
(i) at least one organic UV-screening agent,
(ii) at least one ester chosen from the N-acylamino acid esters of formula:
R′¹(CO)N(R′₂)CH(R′₃)(CH₂)ₙ(CO)OR′₄
in which:
n is an integer equal to 0, 1 or 2,
R′₁ represents a linear or branched C₅ to C₂₁ alkyl or alkenyl radical,
R′₂ represents a hydrogen atom or a C₁ to C₃ alkyl group,
R′₃ represents a radical chosen from the group formed by a hydrogen atom, a methyl group, an ethyl group and a linear or branched C₃ or C₄ alkyl radical,
R′₄ represents a linear or branched C₁ to C₁₀ alkyl radical or a linear or branched C₂ to C₁₀ alkenyl radical or a sterol residue.

2. Composition according to claim 1, characterized in that the organic UV-screening agent(s) is (are) chosen from anthranilates; cinnamic derivatives; dibenzoylmethane derivatives; salicylic derivatives; camphor derivatives; triazine derivatives; benzophenone derivatives; β,β-diphenylacrylate derivatives; benzotriazole derivatives; benzalmalonate derivatives; benzimidazole derivatives; imidazolines; bis-benzazolyl derivatives; p-aminobenzoic -acid (PABA) derivatives; methylenebis(hydroxyphenyl)benzotriazole derivatives; screening polymers and screening silicones; dimers derived from α-alkylstyrene, and 4,4-diarylbutadienes.

3. Composition according to claim 2, characterized in that the organic UV-screening agent(s) is (are) chosen from the following compounds:
Ethylhexyl salicylate,
Butyl methoxydibenzoylmethane,
Ethylhexyl methoxycinnamate,
Octocrylene,
Phenylbenzimidazolesulfonic acid,
Terephthalylidenedicamphorsulfonic acid,
Benzophenone-3,
Benzophenone-4,
Benzophenone-5,
4-Methylbenzylidenecamphor,
Disodium Phenyl Dibenzimidazole Tetra-Sulfonate
Anisotriazine,
Ethylhexyltriazone,
Diethylhexylbutamidotriazone,
Methylenebis(benzotriazolyl)tetramethylbutylphenol,
Drometrizole trisiloxane,
2-[(p-(tert-butylamido)anilino]-4,6-bis[(p-(2′-ethylhexyl-1′-oxycarbonyl)anilino]-1,3,5-triazine,
2,4,6-tris[p′-(2′-ethylhexyl-1′-oxycarbonyl)-anilino]-1,3,5-triazine,
2,4-bis{[4-(2-ethylhexyloxy)-2-hydroxy]phenyl}-6-(4-methoxyphenyl)-1,3,5-triazine,
2,4,6-tris(diisobutyl 4′-aminobenzalmalonate)-s-triazine,
and mixtures thereof.

4. Composition according to any of the preceding claims, characterized in that the amino acid ester is isopropyl N-lauroylsarcosinate
CH₃—(CH₂)₁₀CO—N(CH₃)—CH₂—COO—CH₂—(CH₃)₂

5. Composition according to any of the preceding claims, such that the polyamide has the formula: 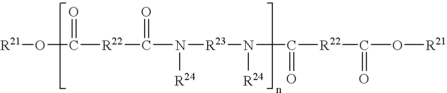
in which n denotes an integer of amide units such that the number of ester groups represents from 10% to 50% of the total number of ester and amide groups; R²¹ is, independently in each case, an alkyl or alkenyl group containing at least 4 carbon atoms and in particular from 4 to 24 carbon atoms; R²² represents, independently in each case, a C₄ to C₅₅ hydrocarbon-based group, on condition that at least 50% of the groups R²² represent a C₃₀ to C₅₅ hydrocarbon-based group; R²³ represents, independently in each case, an organic group containing at least 2 carbon atoms, hydrogen atoms and optionally one or more oxygen or nitrogen atoms; and R²⁴ represents, independently in each case, a hydrogen atom, a C₁ to C₁o alkyl group or a direct bond to R²³ or to another R²⁴, such that the nitrogen atom to which R²³ and R²⁴ are both bonded forms part of a heterocyclic structure defined by R²⁴—N—R²³, with at least 50% of the groups R²⁴ representing a hydrogen atom.

6. Composition according to any of the preceding claims, characterized in that it comprises, in a physiologically acceptable medium, from 0.05% to 30% and preferably from 0.1% to 25% by weight of at least one organic UV-screening agent, relative to the total weight of the composition.

7. Composition according to any of the preceding claims, characterized in that it comprises, in a physiologically acceptable medium, from 0.1% to 60% and preferably from 1 to 30% by weight of N-acylamino acid ester derivative, relative to the total weight of the composition.

8. Composition according to any of the preceding claims, characterized in that it comprises, in a physiologically acceptable medium, from 0.5% to 80% and preferably from 5% to 40% by weight of polyamides, relative to the total weight of the composition.

9. Composition according to any of the preceding claims, characterized in that it also comprises nacres, or coated or uncoated metal oxide pigments or nanopigments.

10. Composition according to claim 9, characterized in that said pigments or nanopigments are chosen from titanium oxide, zinc oxide, iron oxide, zirconium oxide and cerium oxide, and mixtures thereof, which are coated or uncoated.

11. Composition according to any of the preceding claims, characterized in that it also comprises at least one agent for artificially tanning and/or browning the skin.

12. Composition according to any of the preceding claims, characterized in that it also comprises at least one adjuvant chosen from fatty substances, organic solvents, emulsifiers, ionic or nonionic thickeners, softeners, opacifiers, stabilizers, emollients, silicones, antifoams, moisturizers, fragrances, preserving agents, surfactants, fillers, polymers, propellants, acidifying or basifying agents, dyes and vitamins.

13. Composition according to any of the preceding claims, characterized in that it is a composition for protecting the human epidermis or an antisun composition and in that it is present in the form of a nonionic vesicular dispersion, an emulsion, in particular an emulsion of water-in-oil type, of oil-in-water type, a cream, or a triple (W/O/W or O/W/O) emulsion, a milk, a gel, a cream-gel, a suspension, a dispersion, a powder, a solid stick, a foam or a spray.

14. Composition according to one of claims 1 to 12, characterized in that it is an anhydrous composition comprising at least one 1,3,5-triazine derivative.

15. Composition according -to one of claims 1 to 10, characterized in that it is a composition for protecting the hair against ultraviolet rays and in that it is in the form of a shampoo, a lotion, a gel, an emulsion, or a nonionic vesicular dispersion.

16. Composition according to one of claims 1 to 15, such that the polyamide is combined with a linear or branched fatty alcohol, in particular oleyl alcohol, isocetyl alcohol or octyldodecanol.

17. Dermatological composition according to one of claims 1 to 16, such that it comprises at least one active agent chosen from the group formed by antioxidants, free-radical scavengers, α-hydroxy acids, vitamins, insect repellents, anti-inflammatory agents and substance P antagonists.

18. Use of a composition as claimed in any of the preceding claims, in or for the manufacture of cosmetic or dermatological compositions for protecting the skin and/or the lips and/or the integuments against ultraviolet radiation, in particular sunlight.

19. Cosmetic process for protecting the skin and/or the lips and/or the integuments against UV radiation, in particular sunlight, characterized in that it consists in applying to the skin and/or the lips and/or the integuments a cosmetic composition as claimed in one of claims 1 to 16.

20. Use of at least one N-acylamino acid ester of formula:
R′¹(CO)N(R′₂)CH(R′₃)(CH₂)ₙ(CO)OR′₄
in which:
n is an integer equal to 0, 1 or 2,
R′₁ represents a linear or branched C₅ to C₂₁ alkyl or alkenyl radical,
R′₂ represents a hydrogen atom or a C₁ to C₃ alkyl group,
R′₃ represents a radical chosen from the group formed by a hydrogen atom, a methyl group, an ethyl group and a linear or branched C₃ or C₄ alkyl radical,
R′₄ represents a linear or branched C₁ to C₁₀ alkyl radical or a linear or branched C₂ to C₁₀ alkenyl radical or a sterol residue,
in compositions structured with a polyamide, containing a UV-screening agent, in order to improve the sun protection factor of this composition.
